(19) United States
(12) Patent Application Publication
(10) Pub. No.: US 2015/0178634 A1
(43) Pub. Date: Jun. 25, 2015

(54) METHOD AND APPARATUS FOR HANDLING BUGS

(71) Applicant: EMC Corporation, Hopkinton, MA (US)

(72) Inventors: Kai Chen, Shanghai (CN); Jun Tao, Shanghai (CN); Bo Chen, Shanghai (CN); Ping Chen, Shanghai (CN)

(21) Appl. No.: 14/568,738

(22) Filed: Dec. 12, 2014

(30) Foreign Application Priority Data
Dec. 23, 2013 (CN) CN201310724705.3

(51) Int. Cl. G06N 5/04; G06N 99/00

(52) U.S. Cl. CPC G06N 5/048; G06N 99/005

(57) ABSTRACT

Embodiments of the present disclosure relate to a method and apparatus for handling bugs of a target product by building a bug prediction model for the target product at least in part based on a field to which the target product is applied, the bug prediction model indicating a threshold associated with at least one performance parameter of the target product; and automatically predicting a potential bug associated with the target product based on the bug prediction model for the target product. Other embodiments are also disclosed.

### RELATED APPLICATION

This Application claims priority from Provisional Application Serial No. CN201310724705.3 filed on Dec. 23, 2013 entitled “METHOD AND APPARATUS FOR FAULT HANDLING,” the content and teachings of which are hereby incorporated by reference in their entirety.

### FIELD OF THE INVENTION

The present disclosure generally relates to the field of computer, and more specifically, relates to handling bugs.

### BACKGROUND

Support and maintenance become important issues after a product is deployed and put into use. In the current support model, a customer usually contacts technical support staff after a bug or a problem occurs, when the product or a device malfunctions. In other words, the base of the support model is post-bug remediation. This model likely affects the customer's businesses and causes negative consequences or experiences.

A number of schemes exist for bug prediction. For example, bugs may be predicted by detecting the running (hereinafter also referred to as active) state of a hardware device and/or software program. For example, it may be predicted whether a bug is likely to occur by detecting the central processing unit (CPU) overloaded, disk input/output (I/O) abnormalities etc. However, for different customers, use case scenarios, fields, and the like, expressions of a bug may have a discrepancy. For example, although it may be decided whether a system is in a healthy state by judging whether the CPU utilization exceeds a predetermined threshold, it becomes hard to set an appropriate value for such threshold. It is because different customers, fields, and application scenarios always have completely different definitions of an unhealthy state.

### SUMMARY OF THE INVENTION

Embodiments of the present disclosure provide a method and apparatus efficiently and effectively for handling bugs.

According to an embodiment of the present disclosure, there is provided a method for handling bugs of a product. The method comprises: building a bug prediction model for the product/target product at least in part based on a field to which the target product is applied, the bug prediction model indicating a threshold associated with at least one performance of the target product; and predicting a potential bug associated with the target product based on the bug prediction model for the target product, preferably without any manual intervention.

According to aspect further embodiment of the present disclosure, there is provided an apparatus for handling bugs of a target product. The apparatus comprises: a bug model building unit configured to build a bug prediction model for the target product at least in part based on a field to which the target product is applied, the bug prediction model indicating a threshold associated with at least one performance of the target product; and a bug prediction unit configured to automatically predict a potential bug associated with the target product based on the bug prediction model for the target product. In one embodiment the bug model building unit and the bug prediction unit can be combined into a single bug BP unit, wherein the bug BP unit can singly achieve the tasks of the individual units.

It would be understood through the description below that according to the embodiments of the present disclosure, first, a target product may be classified by application field, and then, for different target products in each class, methodology such as machine learning and/or other artificial intelligence (AI) or natural language processing (NLP) methods may be applied to find a rule in product performance of the same class of products upon occurrence of failure. By applying such field-based bug prediction model, a potential bug of the product (target product) can be predicted more accurately and promptly. In this way, the predicted bug may be prevented or remediated in advance. Further, the result of automatic remediation may be fed back to the bug prediction model so as to adaptively update the bug prediction model. Other advantages that can be achieved by the present disclosure will become clear from the description below.

### BRIEF DESCRIPTION OF THE DRAWINGS

The above and other objectives, features and advantages of the embodiments of the present disclosure will become more comprehensible through the following detailed description with reference to the accompanying drawings. In the drawings, several embodiments of the present disclosure are illustrated exemplarily, rather than restrictively, wherein:

FIG. 1 illustrates a flow chart of a method for handling bugs according to one exemplary embodiment of the present invention;

FIG. 2 illustrates a flow chart of a method for handling bugs according to another exemplary embodiment of the present invention;

FIG. 3 illustrates a block diagram of an apparatus for handling bugs according to one exemplary embodiment of the present invention;

FIG. 4 illustrates a block diagram of a computer system for handling bugs according to one exemplary embodiment of the present invention; and

In respective drawings, same or corresponding reference numerals represent same or corresponding portions.

### DETAILED DESCRIPTION

Hereinafter, several exemplary embodiments shown in the drawings will be referenced to describe the principle of the present disclosure. It should be understood that description of these embodiments is only for enabling those skilled in the art to better understand the present disclosure, rather than limiting the scope of the present disclosure in any manner.

The main idea of the present disclosure lies in that if bugs can be predicted and even automatically remediated, preferably without any manual intervention, before a problem occurs, it will significantly enhance user experience and maintenance effect, and currently there is a need for a more effective and efficient bug handling solution. According to embodiments of the present disclosure, first, classifying (identifying/assigning a class for) a product by an application field; then, for each class of different products, applying methodology such as machine learning and/or AI and/or NLP to find a rule in product performance of the same class of products upon occurrence of product performance. By applying such field-based bug prediction model, a potential bug of the target product can be predicted more accurately and promptly. In this way, a prevention or remediation in advance may be performed on the predicted bug. Moreover, the result of automatic remediation may be fed back to the bug prediction model so as to adaptively update the bug prediction model.

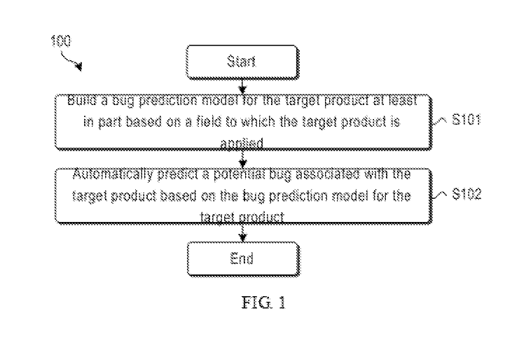

Reference is now made to FIG. 1, which illustrates a flow chart of a method 100 for handling bugs of a target product according to exemplary embodiments of the present disclosure. After the method 100 starts, at step S101, a bug prediction model for the target product is built at least partly based on a field to which the target product is applied. The term “target product” used here may refer to a physical product such as device, apparatus, system, etc., or a computer program product or an application in general.

According to embodiments of the present disclosure, a field to which a target product is applied may be obtained using a plurality of manners/approaches. For example, in some embodiments, the field may be obtained from information maintained by a sales team and/or support team. Alternatively, the field information may also be provided by a manufacturer, provider and/or seller of the product. For another example, the application field information may also be obtained from relevant material such as a product manual. The scope of the present disclosure is not limited in this aspect.

According to some embodiments of the present disclosure, classification of a target product based on application field may also be performed manually. Alternatively, the target product may also be automatically classified based on a machine classification algorithm such as clustering. The embodiments in relation to this aspect will be described in detail below.

After the product is classified, a bug prediction model may be built based on the result of classification. Specifically, assume a target product is classified into a specific product group. At this point, based on previous bug information of other products in the same group, a bug prediction model for the target product may be built. In the context of the present disclosure, the bug prediction model is used for indicating a threshold for at least one performance of the target product. The performance may include, but not be limited to, CPU load, memory utilization, network condition, I/O condition, etc. When the actual measurement value of the performance of the target product is higher or lower than the threshold, it is believed that a potential bug is likely to occur. As an example, according to the embodiments of the present disclosure, if it is found that the CPU load substantially exceeds 90% within a predetermined interval before a bug occurs to the same class of products in the same group, then the threshold for the performance index “CPU load” of the target product may be set at 90%.

According to the embodiments of the present disclosure, for any given performance, the values of the performance of the products within the same group may be averaged (for example, arithmetic average, weighted average, etc.). The resulting average value may be used as a threshold associated with this performance of the target product. Alternatively, a machine learning algorithm may also be applied to the same kind of products in the same group so as to build a more accurate bug prediction model. For example, according to the embodiments of the present disclosure, various machine learning algorithms may be applied to obtain a rule for a given performance of a specific class of products within a predetermined period of time before occurrence of the bug. Such machine learning algorithm includes, but is not limited to, principle components analysis (PCA), independent components analysis (ICA), canonical correlation analysis (CCA), and probability potential components analysis (PLCA), etc. The preferred embodiments with respect to this aspect will be described in detail hereinafter.

Next, the method 100 proceeds to step S102, where a potential bug associated with the target product is automatically predicted based on the bug prediction model of the target product. In the implementation, one or more performances of the target product may be monitored in real-time or periodically, for example, CPU load, I/O abnormally, memory utilization, etc. The monitored performance measurement value may be compared with the corresponding performance threshold indicated by the bug prediction model. Once the measured values of one or more performances are determined to be higher or lower than a corresponding threshold, it may be predicted that a bug is likely to occur on the target product. Moreover, it would be understood that based on historical information of bugs of products within the same group, a particular type of a bug likely to occur may be determined.

In this way, pre-judgment for a potential bug may be accomplished before actual occurrence of the bug. In particular, since the bug prediction model of the target product is built specifically for the field of the target product, bug prediction can be made more accurately. It is under the assumption that in the same or similar application field or scenario, before an abnormality or a similar abnormality occurs, the same performance tends to have a higher similarity.

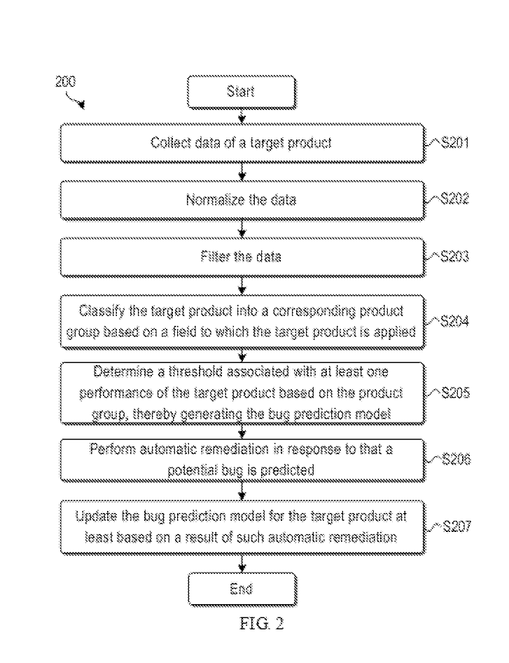

Reference is now made to FIG. 2, which illustrates a flow chart of a method 200 for handling bugs of a target product according to exemplary embodiment of the present disclosure. It would be appreciated that the method 200 may be regarded as a specific implementation of the method 100 described above with reference to FIG. 1.

At step S201, data associated with performance of the target product and previous bug are collected. According to the embodiments of the present disclosure, a log associated with the target product may be one of the sources of data collection. In particular, according to the embodiments of the present disclosure, the data about the previous bugs and performances of the product may be obtained through log. As is already known, after a product is deployed or put into use, a log associated with the product is generally maintained. The log at least records historical bug information of the product. The historical bug information, for example, includes types of bugs occurring previously, time of occurrence, measured values of various performances upon occurrence of a bug, and the like. For example, many products and software put into use would maintain a running log, and at certain time intervals (e.g., one day), the log will be transferred to the backstage data center. In this way, relevant data may be drawn from the log. Of course, the embodiments of the present disclosure do not necessarily rely on a log. Alternatively, relevant bug and performance information may be input manually by the user. The scope of the present disclosure is not limited in this aspect.

Next, at step S202, the data collected is normalized. According to the embodiments of the present disclosure, the data collected, which may be of different formats/types may be normalized into formatted data. For example, the data may be parsed to a database of any designated type, and assists in subsequent machine data parsing.

At step S203, data are filtered. The raw data collected may include various different attributes. However, such raw data are not certainly applied directly to bug detection. For example, the raw data collected may include a version number of the disk, which, however, might be useless for bug detection. As another example, disk speed (IOPS) may characterize the speed capacity of the disk. However, such information does not suffice to describe the trend of I/O throughput of the disk. Therefore, in some embodiments, the raw data may be subject to statistical computation. Alternatively or additionally, new data attributes may be added, which for example include, maximum or minimum and/or average value of measured values of such as CPU, storage, I/O. From the trend of these attribute value, e.g., increase rate, decrease rate, and the like; a more appropriate attribute may be obtained to describe the state and attribute of the target product.

Additionally, redundant data and/or error-prone data included in the data may be removed s to avoid any inaccuracies with respect to the prediction result. In order to remove the noise in the data, various appropriate filters may be applied to the data, e.g., Gauss filter, etc. Further, for consecutive and infinite data, these consecutive attributes may be discrete.

At step S204, based on the field to which the target product is applied, the target product is classified to the corresponding product group. As stated above, in some embodiments, the sales team and/or support team maintains information about a customer of a product, including the customer background information, company information, business field, use case scenario, etc. A product may be classified based on such information. Specifically, in some embodiments, for a plurality of products including the target product, they may be clustered based on their application fields and use case scenarios. The resulting cluster is used as a product group. Any currently known or future developed clustering methods may be used, for example, a classification cluster, a hierarchical cluster, a density cluster, a grid cluster, and a model-based cluster, and the like.

Next, at step S205, a threshold associated with at least one performance of the target product is determined based on the product group, thereby generating the bug prediction model. As stated above, for products in the same group, the previous performance states of these products upon occurrence of bugs may be summed. For example, for any given performance, the measured values of the performance for the products in the same group within a specific period of time before a particular type of bug occurs may be determined, and an associated rule may be determined. As an example, in some embodiments, an average value of the measured values of a given performance associated with the products in the same group within a particular period of time before occurrence of the bug of a particular type may be calculated (e.g., arithmetic average, weighted average, etc.). The resulting average value may be used as a threshold of the performance of the target product with respect to the particular type of bug.

Alternatively or additionally, as stated above, machine learning analysis may be performed on the previous measured values of the performance of the product in the same product group for a given type of performance and bug. Therefore, a more accurate bug prediction model may be built. For example, in some embodiments, for the products in the same group, statistical analysis may be applied to previously measured values of the performance when the bug has occurred or within a particular period of time before the occurrence of the bug to build a statistical based model. As an example, PCA analysis may be applied to determine a dominant appearance of the performance when or before the bug occurs. The scope of the present disclosure is not limited thereto.

Next, the method 200 proceeds to step S206. At step S206, if a potential bug is predicted, as a response, remediation may be performed to the potential bug, automatically, without any human intervention. According to the embodiments of the present disclosure, remediation of a bug may refer to a dedicated library. This library stores information about various kinds of bugs and actions that are needed to be taken for remediating the bugs. Alternatively or additionally, response to predicting a potential bug, a prompt or alarm may be emitted to a human user (e.g., some technical people), such that the user can promptly debug and handle the bug.

Then, at step S207, the bug prediction model for the target product is updated at least in part based on a result of such remediation. Specifically, in some embodiments, an apparatus or application in charge of performance monitoring and bug prediction running (being executed or active) at the target product may transmit relevant information about bug prediction, result of automatic remediation of a potential bug, and/or human user operation, back to a party establishing and maintaining the bug prediction model, for example, the backstage data center. Based on such feedback information, the backstage data center may perform update based on the model.

For example, in some embodiments, parameters during the procedure such as clustering and machine learning may be adjusted based on the feedback information, thereby changing the threshold of one or more performances associated with the target product. Alternatively or additionally, performance parameters may be directly adjusted based on feedback information. Further, a new to-be-monitored performance with respect to a particular type of bug may be added to the bug prediction model based on the feedback information. For example, the previous bug prediction model may not consider the I/O state. However, when it is determined that I/O state needs to be considered based on the result of automatic remediation and/or human user feedback, the relevant data may be obtained and an appropriate analysis may be performed on the data, as has been mentioned above. Likewise, an existing monitored performance may also be deleted from the bug prediction model. A prediction-control closed loop is formed by updating the existing bug prediction model using the results of prediction and/or remediation, which facilitates constant improvement of prediction precision and effect of automatic remediation.

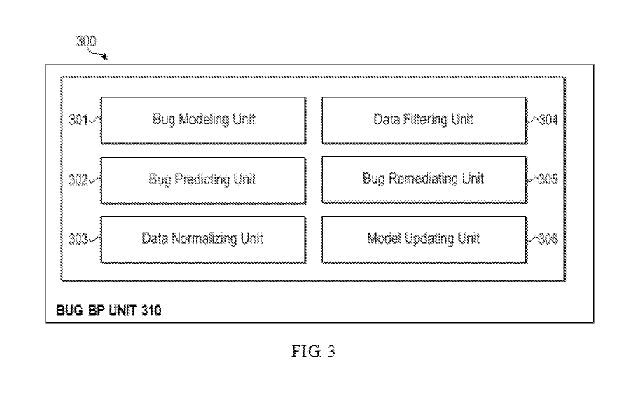

FIG. 3 illustrates a block diagram of an apparatus 300 for handling bugs of a target product according to one exemplary embodiment of the present disclosure. As shown in FIG. 3, according to the embodiments of the present disclosure, the apparatus 300 comprises: a bug model building unit 301 configured to build a bug prediction model for the target product at least in part based on a field to which the target product is applied, the bug prediction model indicating a threshold associated with at least one performance of the target product; and a bug prediction unit 302 configured to automatically predict a potential bug associated with the target product based on the bug prediction model for the target product. In one embodiment, bug model building unit 301 and bug prediction unit 302 can be combined into a single Bug BP Unit 310, which can perform the task of these units.

In some embodiment of the present disclosure, the bug modeling unit 301 may comprise: a product classifying unit configured to classify the target product into a corresponding product group based on the field. In some embodiments of the present disclosure, the bug modeling unit 301 may be configured to determine the threshold associated with at least one performance of the target product based on the product group so as to generate the bug prediction model. In some embodiments of the present disclosure, the threshold associated with at least one performance of the target product is determined based on a log associated with products in the product group. In some embodiments, the apparatus 300 may also comprise at least one of the following: a data normalization unit 303 configured to normalize the data from the log; and a data filtering unit 304 configured to filter the data from the log. In some embodiments of the present disclosure, the threshold associated with at least one performance of the target product is determined by applying machine learning to a previous measurement value of the at least one performance of the products in the product group.

In some embodiments of the present disclosure, the apparatus 300 may comprise a bug remediation unit 305 configured to perform automatic remediation to the potential bug in response to a prediction for the potential bug. In some embodiments of the present disclosure, the apparatus 300 may also comprise a model update unit 306 configured to update the bug prediction model of the target product at least in part based on a result of automatic remediation.

Specifically, as described above, the target product is a device or an application. In one embodiment, each of the sub units disclosed above, can be combined into a single Bug BP Unit 310, which can collectively perform the task of these units in an organized manner.

For the sake of clarity, FIG. 3 does not show some optional components of the apparatus 300. However, it should be understood that various features described above with reference to FIGS. 1 and 2 are likewise applicable to be associated with the apparatus 300. Moreover, various components in apparatus 300 may be hardware modules or software unit modules or a combination thereof. For example, in some embodiments, the apparatus 300 may be implemented partially or completely using software and/or firmware, for example, implemented as a computer program product embodied on a computer readable medium. Alternatively or additionally, the apparatus 300 may be implemented partially or completely based on hardware, e.g., implemented as an integrated circuit (IC), an application-specific integrated circuit (ASIC), a system on chip (SOC), a field programmable gate array (FPGA), etc., and the scope of the present disclosure is not limited in this aspect.

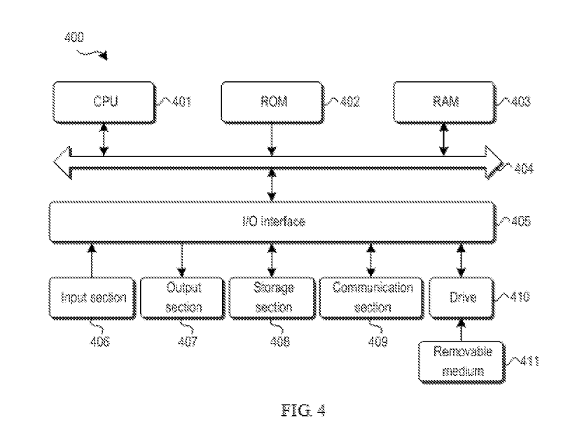

FIG. 4 shows a schematic block diagram of a computer that is adapted to implement the embodiments of the present disclosure. As shown in FIG. 4, the computer 400 includes a CPU (Central Processing Unit) 401 which may perform various appropriate actions and processing based on the program stored in the read-only memory (ROM) 402 or the program loaded from the memory section 408 to the random access memory (RAM). In RAM 403, there further stores various programs and data needed by operation of the apparatus 400. COU 401, ROM 402, and RAM 403 are connected one another via a bus 404. The input/ output (I/O) interface is also connected to the bus 404.

The following components are connected to the I/O interface 405: an input section 406 comprising a keyboard, a mouse, and the like; an output section 407 including such as CRT (Cathode Ray Tube), LCD (Liquid Crystal Display), and loudspeakers; a memory section 408 including a hard disk and the like; and a communication section 409 including a network interface card such as LAN card, Modem, etc. The communication section 409 performs communication processing via a network such as Internet. A driver 410 is also connected to the I/O interface 405 as required. A removable medium 411, such as a magnetic disk, an optical disk, a magnetic-optical disk, a semiconductor memory, etc., are mounted on the driver 410 as required, such that the computer program read from thereon are mounted into the memory section 408 as required. The apparatus 300 may in one embodiment be part of the computer system and may be configured to work with the computer to implement the method of FIGS. 1 and 2.

In particular, according to the embodiments of the present disclosure, the process as described above with reference to FIG. 2 may be implemented as a computer software program. For example, the embodiments of the present disclosure include a computer program product, which includes a computer program tangibly embodied on the machine-readable medium. The computer program includes program code for performing the method 200. In such embodiments, the computer program may be downloaded from the communication section 409 and installed, and/or installed from the removable medium 411.

Generally, various exemplary embodiments of the present disclosure may be implemented in hardware or application-specific circuit, software, logic, or in any combination thereof. Some aspects may be implemented in hardware, while the other aspects may be implemented in firmware or software executed by a controller, a microprocessor or other computing device. When various aspects of the present disclosure are illustrated or described into block diagrams, flow charts, or other graphical representations, it would be understood that the block diagrams, apparatus, system, technique or method described here may be implemented, as non-restrictive examples, in hardware, software, firmware, dedicated circuit or logic, common software or controller or other computing device, or some combinations thereof.

Besides, each block in the flowchart may be regarded as a method step or an operation generated by operating computer program code, and/or understood as a plurality of coupled logic circuit elements performing relevant functions. For example, the embodiments of the present disclosure include a computer program product that includes a computer program tangibly embodied on a machine-readable medium, which computer program includes program code configured to implement the method described above.

In the context of the present disclosure, the machine-readable medium may be any tangible medium including or storing a program for or about an instruction executing system, apparatus or device. The machine-readable medium may be a machine-readable signal medium or machine-readable storage medium. The machine-readable medium may include, but not limited to, electronic, magnetic, optical, electro-magnetic, infrared, or semiconductor system, apparatus or device, or any appropriate combination thereof. More detailed examples of the machine-readable storage medium includes, an electrical connection having one or more wires, a portable computer magnetic disk, hard drive, random-access memory (RAM), read-only memory (ROM), erasable programmable read-only memory (EPROM or flash memory), optical storage device, magnetic storage device, or any appropriate combination thereof.

The computer program code for implementing embodiments of the present disclosure may be complied with one or more programming languages. These computer program codes may be provided to a general-purpose computer, a dedicated computer or a processor of other programmable data processing apparatus, such that when the program codes are executed by the computer or other programmable data processing apparatus, the functions/ operations prescribed in the flow chart and/or block diagram are caused to be implemented. The program code may be executed completely on a computer, partially on a computer, partially on a computer as an independent software packet and partially on a remote computer, or completely on a remote computer or server.

Besides, although the operations are depicted in a particular sequence, it should not be understood that such operations are completed in a particular sequence as shown or in a successive sequence, or all shown operations are executed so as to achieve a desired result. In some cases, multi-task or parallel-processing would be advantageous. Likewise, although the above discussion includes some specific implementation details, they should not be explained as limiting the scope of any invention or claims, but should be explained as a description for a particular embodiment of a particular disclosure. In the present disclosure, some features described in the context of separate embodiments may also be integrated into a single embodiment. On the contrary, various features described in the context of a single embodiment may also be separately implemented in a plurality of embodiments or in any suitable sub-group.

Various amendments and alterations to the exemplary embodiments of the description as above described would become apparent to a person skilled in the relevant art when viewing the above description in connection with the drawings. Any and all amendments still fall within the scope of the non-limiting exemplary embodiments of the present disclosure. Besides, the above description and drawings off an advantage of teaching, and technicians relating to the technical field of these embodiments of the present disclosure would envisage other embodiments of the present disclosure as expounded here.

It would be appreciated that the embodiments of the present disclosure are not limited to the specific embodiments as disclosed, and the amendments and other embodiments should all be included within the appended claims. Although particular terms are used herein, they are used only in their general and descriptive senses, without a purpose of limiting.

What is claimed is:

1. A method for handing bugs of a target product, the method comprising:
constructing a bug prediction model for a product at least in part based on a field to which the product is applied, the bug prediction model indicating a threshold associated with at least one performance parameter of the product; and
predicting a potential bug associated with the product based on the bug prediction model for the product, wherein the product comprises at least one of a device or an application.

2. The method according to claim 1, wherein constructing a bug prediction model for the product at least in part based on a field to which the product is applied comprises:
classifying the product into a corresponding product group based on the field.

3. The method according to claim 2, further comprises:
determining the threshold associated with at least one performance parameter of the product based on the product group.

4. The method according to claim 3, wherein the threshold associated with at least one performance parameter of the product is determined based on a log associated with the product in the product group.

5. The method according to claim 4, further comprising at least one of:
extracting data from the log;
normalizing the data extracted from the log; and
filtering the data from the log.

6. The method according to claim 3, wherein the threshold is determined by applying machine learning to previously measured values of the at least one performance parameter of the product in the product group.

7. The method according claim 1, further comprising:
performing remediation to the potential bug in response to the potential bug being predicted without any human intervention.

8. The method according to claim 7, further comprising:
updating the bug prediction model for the product at least in part based on the remediation.

9. An apparatus for handing bugs of a target product, the apparatus comprising:
a bug BP unit configured to
construct a bug prediction model for a product at least in part based on a field to which the product is applied, the bug prediction model indicating a threshold associated with at least one performance parameter of the product; and
predict a potential bug associated with the product based on the bug prediction model for the product, wherein the product comprises at least one of a device or an application.

10. The apparatus according to claim 9, further configured to:
classify the product into a product group based on the field.

11. The apparatus according to claim 10, further configured to determine the threshold associated with at least one performance parameter of the product based on the product group.

12. The apparatus according to claim 11, wherein the threshold associated with at least one performance parameter of the product is determined based on a log associated with products in the product group.

13. The apparatus according to claim 12, further comprising at least one of:
extracting data from the log;
normalizing the data extracted from the log; and
filtering the data from the log.

14. The apparatus according to claim 11, wherein the threshold is determined by applying machine learning to previously measured values of the at least one performance parameter of the product in the product group.

15. The apparatus according to claim 9, further configured to:
perform remediation to the potential bug in response to the potential bug being predicted without any human intervention.

16. The apparatus according to claim 15, further configured to:
update the bug prediction model for the product at least in part based on the remediation.

17. A computer program product for handing bugs of a target product, wherein the computer program product is tangibly stored in a non-transient computer-readable medium and includes a machine executable instruction that, when being executed, performs
constructing a bug prediction model for a product at least in part based on a field to which the product is applied, the bug prediction model indicating a threshold associated with at least one performance parameter of the product, and classifying the product into a corresponding product group based on the field; and
predicting a potential bug associated with the product based on the bug prediction model for the product, wherein the product comprises at least one of a device or an application.

18. The computer program product according to claim 17, further comprising:
determining the threshold associated with at least one performance parameter of the product based on the product group, wherein the threshold associated with at least one performance parameter of the product is determined based on a log associated with the product in the product group, and wherein the threshold is determined by applying machine learning to previously measured values of the at least one performance parameter of the product in the product group.

19. The computer program product according to claim 18, further comprising at least one of:
extracting data from the log;
normalizing the data extracted from the log; and
filtering the data from the log.

20. The computer program product according claim 17, further comprising:
performing remediation to the potential bug in response to the potential bug being predicted without any human intervention, and updating the bug prediction model for the product at least in part based on the remediation.
